(19) United States
(12) Patent Application Publication
(10) Pub. No.: US 2025/0116634 A1
(43) Pub. Date: Apr. 10, 2025

(54) METHOD FOR AUTOMATED DEFECT CLASSIFICATION IN SCANNING ACOUSTIC MICROSCOPY AND SCANNING ACOUSTIC MICROSCOPE

(71) Applicant: PVA TEPLA ANALYTICAL SYSTEMS GMBH, Westhausen (DE)

(72) Inventors: Peter HOFFROGGE, Oberkochen (DE); Arya NAIR SUKUMARAN, Aalen (DE); Luca BAUMANN, Westhausen (DE); Mario WOLF, Nossen (DE)

(73) Assignee: PVA TEPLA ANALYTICAL SYSTEMS GMBH, Westhausen (DE)

(21) Appl. No.: 18/982,505

(22) Filed: Dec. 16, 2024

Related U.S. Application Data
(63) Continuation of application No. PCT/EP2023/076671, filed on Sep. 27, 2023.

(30) Foreign Application Priority Data
Oct. 4, 2022 (DE) 10 2022 125 479.8

(51) Int. Cl. G01N 29/44; G01N 29/06; G01N 29/22; G01N 29/34

(52) U.S. Cl. CPC G01N 29/4481; G01N 29/0681; G01N 29/225; G01N 29/343; G01N 29/4445; G01N 29/449

(57) ABSTRACT

A method for automated defect classification of a sample: scanning, by a scanning acoustic microscope, a sample in a predefined frequency range, the scanning acoustic microscope comprises one or more ultrasonic transducers, the sample is positioned stepwise relative to the one or more ultrasonic transducers at raster points, one or more ultrasound signals are generated at each raster point and recorded after at least one of reflection on the sample and transmission by the sample, digitizing one or more chronological sequences of the one or more recorded ultrasound signals; analyzing the digitized one or more chronological sequences; and classifying the analyzed one or more chronological sequences into defect classifications using at least one neural network that is trained based on a deep learning model that uses training data including scanning acoustic microscope scans of one or more control samples of the same type as the sample.

### CROSS-REFERENCE TO RELATED APPLICATION

The present application is a continuation of PCT/EP2023/076671 filed on Sep. 27, 2023, which claims priority to DE 10 2022 125 479.8, filed on Oct. 4, 2022, the entire contents of each of which is incorporated herein by reference.

### BACKGROUND

The present disclosure relates to a method for automated defect classification of a sample by means of scanning acoustic microscopy, non-transitory computer program product as well as a scanning acoustic microscope.

### FIELD

Quality inspection by means of ultrasound, also called acoustic microscopy, enables the non-destructive measurement and inspection of materials and components. During image generation in a scanning acoustic microscope, a sample to be examined is scanned line by line and a short ultrasound pulse is generated on each pixel, whose ultrasound signal reflected by the sample is evaluated pixel by pixel. Typically, the chronological sequence of the signal is analyzed within a specified time range (gate). The time range to be analyzed may also be defined relative to the surface signal of the sample to ensure that the sample is imaged at a previously specified depth relative to the surface (surface trigger).

### DESCRIPTION OF RELATED ART

Generally, the maximum signal intensity resp. amplitude within the selected time range is represented by a gray scale value for each pixel resp. each raster point, and thus an image of the sample is generated. However, complex data processing operators such as filters or transformations may also be employed in order to generate this gray scale value. The produced micrographies image the sample in the plane perpendicular to the transducer and are referred to as a C-scan. A further imaging mode is the B-scan. A B-scan represents an acoustic cross section through the sample. A location coordinate is plotted along the X-axis of the image, the time of flight of the sound signal along the Y-axis.

In the case of using scanning acoustic microscopy in production control and statistical quality control, the evaluation of the C-scan images is generally performed by automated image processing. In this case, apart from conventional algorithms, like threshold value analyses, morphological filters and matrix-based image operations, also image-based solutions by means of artificial intelligence are employed. It is the purpose of image processing to reliably detect critical flaws in the components with as few misevaluations as possible in the form of false positive evaluated structures.

To this end, one or more images are transferred from the ultrasound inspection to an image processing, which then examines the received images for various features. The coordinates of the found flaws or as well properties are then transmitted to a manufacturing control system. In some cases, a final good/bad evaluation is performed and defective components are sorted out. In particular, in the field of semiconductor manufacturing, the communication standard SECS/GEM is used for the connection.

This method works well with classic semiconductor components such as individual components with a plastic socketing compound, DCB-based power electronics with classic solder joints, or wafers joined together by means of fusion bonding. In all these applications, it is possible to display defects with an unambiguous brightness compared to the remaining flawless regions.

Methodological limits for the conventional image processing are always reached when the brightness value of a pixel can no longer be unambiguously allocated to a flaw and the same gray scale value can occur both in the case of component defects and in the case of intact structures. Here, the capability of image processing can be improved by identifying the component regions and merely performing a local analysis.

The analysis of the ultrasound data of complex components is often no longer feasible with conventional image processing. In the case of complex image contents, image analysis based on machine learning may also be used. However, image-based machine learning requires large amounts of data for training neural networks. In particular, for training rarely occurring types of defects, it can be very elaborate to get the required high number of defective components. For example, a workaround is an artificial amplification of a few exemplary defects. However, this can lead to misinterpretations of the network, as non-representative data is used for training. Approaches with image-based artificial intelligence are therefore very complex and little reliable in the application of defect recognition in acoustic microscopy on materials and components, since only insufficient image material is available for training the artificial neural networks and insufficiently good data sets are available for comprehensive modeling.

### SUMMARY

An object of the present disclosure is to improve the automatic defect recognition in the non-destructive examination of even complex materials and components, for example complex semiconductor samples.

This object can be achieved by a method for automated defect classification of a sample by means of scanning acoustic microscopy, for example, in the frequency range of 10 MHz to 2000 MHz, wherein a sample can be scanned with an scanning acoustic microscope with one or more ultrasonic transducers, the sample can be positioned stepwise relative to the ultrasonic transducer or transducers at raster points, and one or more ultrasound signals can be generated at each raster point and recorded after reflection on and/or in the sample and/or after transmission by the sample, wherein the chronological sequences of the recorded ultrasound signals reflected and/or transmitted can be digitized and analyzed, such as, classified, with regard to defects by means of at least one neural network, which had previously been trained unsupervised in an initial training by means of a deep learning algorithm with the help of scanning acoustic microscope scans of one or more control samples of the same type as the sample or with known and labeled defects. The method according to the present disclosure is applicable to diverse types of samples, from simple material samples to complex semiconductor samples, and can be based on the fact that scanning acoustic microscopes, which can correspond to the current state of the art, can allow the sound signals to be detected at each scanning point, processed in real time and stored. These chronological sequences can also be referred to as A-scan signals. Therewith, instead of a previously image-based analysis, a signal- or volume-based analysis of the complete chronological signal sequences can be performed.

In principle, the problem of unavoidable data reduction in the prior image-based analysis is hereby avoided, which is caused in that during the image generation for each pixel, thus each raster point, the respectively detected and perhaps complex ultrasound signal is reduced to a single value, for example the maximum of the amplitude in the time frame considered. With this reduction, the comprehensive information contained in the ultrasound signal can be lost for the analysis. This leads, among other things, to the noise of a single gray scale value reaching a critical magnitude in comparison to the required threshold values in a conventional image analysis, such as at high amplifications, and negatively affecting the certainty of a flaw decision.

The ultrasound signal of complex semiconductor samples often contains signal portions that not only correspond directly to the coupled compression wave, but signal portions are also generated by other wave types. In fast materials, a so-called mode conversion may occur. Here, a coupled compression wave generates both a compression wave portion and a shear wave portion at the interface, both of which move at different propagation speeds in the sample and thus generate temporally shifted echo signals. If two interfaces with a large reflection coefficient are opposite to each other, multiple echoes are formed, which are caused by sound waves reflected back and forth. Transducers with a large aperture angle can also cause Rayleigh and Lamb waves in solid bodies. All of these signals can be used for a defect/non-defect decision. A weakly developed defect thus generates characteristic signatures at many different locations of the signal. These signatures supply a better data base for identification of defects than just a single gray scale value, as different parts of the signal can be used for the analysis.

The use of an artificial neural network that can evaluate and classify the overall signal of an interface increases the reliability of the network's decisions in its analysis of the data and exceeds that of image-based methods. In contrast to the often limited data availability and the considerable human effort in the case of labeling image data, which are required for training an artificial neural network for image data analysis, the presented method utilizes the classification of individual A-scan signals. For this purpose, it can be sufficient to train an artificial neural network with a plurality of A-scan signals from representative and relevant regions. Even a 4-digit number of such signals represents only a small percentage of the total amount of data with respect to a complete C-scan image.

The method according to the present disclosure is directed to training the network with signals from the relevant region, so that the network can derive information and examine the usability of the complete information of the signal for the deep learning network training. Deep learning networks are very efficient in automated feature extraction and often obtain better results herein than can be attained in the case of a manual selection. By correct optimization and continuous learning, deep learning networks are able to draw more conclusions than a human operator. 3D data that are detected by the scanning acoustic microscope are used as raw data for training the statistical model. These data make it possible to reconstruct all individual gate settings like A-scan, C-scan, B-scan, slice and 3D-scan (including amplitude and time-of-flight data) so that the sample can be displayed in individual layers.

While previous methods are reliant on the clean signals of ultrasonic transducers in their applicability and are overwhelmed in the case of broadband ultrasonic transducers due to the many signals of different origin, in embodiments of the method according to the present disclosure, the ultrasonic transducer or transducers can be designed as broadband ultrasonic transducer, such as with a bandwidth of at least 10%, in some examples at least 20%, wherein the ultrasonic transducer or transducers can be designed to record signals, which are produced from mode conversion, multiple echoes, Rayleigh waves, Lamb waves and/or due to intrinsic properties of the transducer, and to forward them to a receiver.

The method according to the present disclosure uses neural networks that have been trained either supervised or unsupervised. In the first case, a control sample or several control samples, at least one of which is defective, can be scanned, the defects of which are either visible to an expert or are known from other examinations. The expert then marks one or more regions of the control sample that can be flawless and one or more defective regions. The training of the neural network can prepare it to assign corresponding ultrasound signals to one of the categories. In the case of the deep learning, it is not preset, which signal structures are concerned, but the neural network can find the most meaningful signal structures by itself.

In the case of unsupervised learning, a control sample can be scanned that has no defects. The ultrasound signals of this control sample can show the neural network trained therewith how the ultrasound signals should ideally look like. In the training phase, the neural network has learned thereby the full range of acceptable signals for different structures of the control sample. This can be a large plurality of different structures and corresponding signal sequences that would not have been imageable in conventional manner. If a defective sample is scanned later, the ultrasound signals at the positions of the defects will not be in the spectrum of the acceptable signals, but will differ from them. With the help of a criterion, which describes the deviation from the ideal signal image, it can then be assessed whether or not a defect is present.

In this context, it can be sensible to train the neural network with ultrasound signals that have been recorded with the same parameters as the signals to be classified later. This concerns, among other things, the bandwidth and transmission characteristics of the ultrasonic transducers, but also the signal frequency of the ultrasound pulse.

In embodiments, the ultrasonic transducer or transducers can be designed as broadband ultrasonic transducer or transducers, such as with a bandwidth of at least 10%, in some examples at least 20%, wherein the ultrasonic transducer or transducers can be designed to record signals, which are produced from mode conversion, multiple echoes, Rayleigh waves, Lamb waves and/or due to intrinsic properties of the transducer, and to forward them to a receiver. Due to their high bandwidth, the ultrasound signals transmitted by broadband ultrasonic transducers can include substantially more information than the usually used ultrasonic transducers, which comprise a smaller bandwidth or are operated with a smaller bandwidth. In the case of using broadband ultrasonic transducers, this information density has made it impractical so far to apply a corresponding image analysis based on neural networks to data generated with the help of broadband ultrasonic transducers. The method according to the present disclosure, on the other hand, can utilize the additionally available information for improvement of the sharpness of separation of the classification. The high information density of the broadband signals also makes it possible to enable the training of the neural networks with the help of only one or very few scans.

In embodiments, the neural network can be a convolutional neural network (CNN) with a 1-D-resnet architecture with 1-dimensional convolutional blocks, wherein the deep learning algorithm can include an automated feature extraction. Alternatively, the neural network can be a recurrent neural network (RNN), with a Long Short-Term Memory (LSTM) or Gated Recurrent Unit (GRU)-based architecture, where the deep learning algorithm can include an adaptation of a feed-forward stage of the RNN. The neural network may also be designed as a hybrid of a CNN and an RNN.

In embodiments, the ultrasound signals can be smoothed by means of a deterministic algorithm prior to the analysis, such as by wavelet filtering, on the basis of Daubechies wavelets or Mexican hat wavelets. Also, the ultrasound signals, with the help of which the neural network has been trained, should have been subjected to the same preprocessing in this case. Smoothing may serve for elimination of signal artifacts that may be produced due to instrument design.

In embodiments, the chronological sequence of the ultrasound signals is analyzed as a discrete time series in the form {signal length×1}. Due to the digitization, the discrete time series may contain a length of several thousand data points, resulting in a vector of the same length. In this case, each raster point resp. each pixel is individually analyzed as to whether or not it belongs to a defect. Additionally or alternatively, a volumetric analysis may take place, wherein several ultrasound signals of adjacent raster points are combined and analyzed as discrete time series of raster points arranged in a rectangle of the edge lengths n×m, as a data set of the form {signal length×n×m}, where at least one of n and m is ≥2, n=m, and n and m can be odd numbers. This includes a row-by-row or column-by-column combination of several adjacent pixels resp. a combination of pixels in a rectangular resp. square arrangement, wherein, for example, if an odd number of pixels is selected as the edge length in the case of a square arrangement, the center of the square in turn coincides with the central pixel. In the case of the combination of adjacent pixels, regardless of whether this takes place in a linear or in a planar form, the analysis resp. training of the neural network can be adapted, in that central pixels are weighted higher than peripheral pixels.

A gain in processing performance is attained in embodiments, if the data sets of the discretized ultrasound signals are two-dimensional, with the discretized ultrasound signal in the first dimension and time steps of 1 in the second dimension. The actual value of the time steps depends on the digitization rate of the analog ultrasound signal.

In embodiments, the classification can include one or more classes for the absence of defects, such as with one or more classes for one or more structures, and one or more classes for defects, and/or different kinds of defects.

During the classification, in embodiments, a confidence can be determined for the respective classification, which can be represented in particular in a representation for each raster point by an intensity value.

Among other things, for the systematic analysis of flaws in the production of the samples, it is provided in embodiments to superimpose the classification, such as a confidence, onto a C-scan image as a color or gray scale value for raster points with defect classification, the confidence can be integrated as a brightness parameter, color parameter or transparency parameter.

In embodiments, prior to the processing by the neural network, the ultrasound signals can be converted by means of regression, such as by interpolation or by means of a trained statistical model, into a signal of a predefined length and/or predefined chronological increment, without loss of information with regard to the sample, where noise, signal artifacts and/or interference signals and distortions due to design can be reduced. According to the present disclosure, a loss of information can be the loss of information indicative of the sample, while interference signals and distortions can be inherent in the system and do not contain any information about the sample itself. Although ideally the training data on the control samples are recorded under the same circumstances and parameters as later the ultrasound signals on the samples to be tested, in practice not all test parameters can be accurately repeated, so that it may be useful first to record and analyze the system response to different situations and to remove those portions of the system response that are known during the preprocessing of the ultrasound signals prior to the training and prior to the analysis, such as noise, signal artifacts, interference signals and distortions.

Additionally or alternatively to that, the ultrasound signals may be anomaly-corrected using an encoder-decoder architecture, where the ultrasound signals can be decomposed into components and reconstructed again based on trained domain knowledge, a reconstruction error can be derived from the difference of the input signal and the reconstructed signal. The encoder-decoder architecture can image the received ultrasound signals onto good ultrasound signals, thus, can be an example of a regression. For this purpose, first a statistical model, for example a neural network, can be trained such that it images in turn good signals onto good signals. This is an example of unsupervised learning, which generates the mentioned domain knowledge, which is then contained in the neural network. Anomalous signals that deviate from the good signals due to the presence of defects are in turn imaged onto the previously learned good signals by the encoder-decoder architecture, thus anomaly-corrected. The difference between the output signals and the input signals can form a basis for a defect classification, which can be represented, for example, via threshold values for a degree of the deviation.

In embodiments, a reconstructed 3D data set of the sample volume of the sample can be generated by a trained statistical model in consideration of the properties of the ultrasound propagation in the sample, which can be corrected for effects by defocusing, multiple echoes, mode-converted signals, and intrinsic transducer signals, allowing the generation of sectional images along any planes. These effects can be modeled and calculated back from the ultrasound signals, thus removed.

In embodiments, an untrained neural network or a neural network pre-trained with the help of at least one control sample of foreign types of at least one foreign sample type can be used as the basis for the initial training. The training in the first case can take a bit longer, since the neural network is trained ab initio, while in the latter case there is already information available that only needs to be adapted to the present control sample. Thereby, the learning converges comparatively fast, depending on the similarity with previously trained sample types. After completion of the training for the current sample type, the current version of the neural network can be stored for later use on the same sample type, so that a database for neural networks for different prototypes can be set up without having to train a neural network every time anew.

For the initial training of the neural network, in embodiments, the labeling of defects and other parts of the control sample takes place by hand, such as on a C-scan section, where the regions marked by hand can account for less than 50%, such as less than 20%, or less than 10%, of the area of the scan of the control sample. The method according to the present disclosure thus manages with significantly less starting material, since the full information content of the ultrasound signals for each pixel can be used. Therefore, a restriction to relatively small regions of the control sample suffices.

The object of the present disclosure is also achieved by a non-transitory computer program product with program code means, which, upon execution on a data processing installation of a scanning acoustic microscope, cause the scanning acoustic microscope to execute a method according to the present disclosure described above. Alternatively, the training of the neural network and the analysis of the ultrasound signals may also take place on a separate data processing installation.

Furthermore, the object of the present disclosure is also achieved by an scanning acoustic microscope having a positioning system with a holder for a sample, at least one ultrasonic transducer, such as a broadband ultrasonic transducer, a pulse generating and receiving unit, which is connected or connectible with the at least one ultrasonic transducer, a data processing installation and an analog-to-digital converter unit, wherein the scanning acoustic microscope is designed and configured for performing the methods described according to the present disclosure, such as by a non-transitory computer program product executable and stored in the data processing installation as described in the present disclosure.

The non-transitory computer program product and the scanning acoustic microscope realize the same advantages, properties and features as the method according to the embodiments previously described.

Further features of the present disclosure will become apparent from the description of the embodiments according to the present disclosure together with the claims and the attached drawings. Embodiments according to the present disclosure may fulfill individual features or a combination of several features.

In the context of the present disclosure, features being identified with “in particular” or “preferably” are to be understood as optional features.

### BRIEF DESCRIPTION OF THE DRAWINGS

Further features become clear from the description of embodiments, together with the claims and the accompanying drawings. Individual features or a combination of a plurality of features can fulfil embodiments.

The embodiments will be described below without restricting the general inventive idea with the help of exemplary embodiments with reference to the drawings, and regarding any details according to the present disclosure which are not explained further in the text reference is expressly made to the drawings. They show in:

FIG. 1 illustrates a schematic representation of the signal formation in the scanning acoustic microscopy,

FIG. 2 illustrates a schematic representation of a 1-D CNN architecture,

FIG. 3 illustrates a schematic representation of an LSTM architecture,

FIG. 4 illustrates a schematic representation of an unsupervised deep learning,

FIG. 5 illustrates a schematic representation of a deep learning with preprocessing,

FIG. 6 illustrates time sequence signals from different classifications,

FIG. 7 illustrates a schematic representation of a general work flow in a data analysis by means of machine learning, and

FIG. 8 illustrates a schematic representation of components of a method according to the present disclosure.

In the drawings, the same or similar types of elements and/or parts are provided with the same reference numbers so that a corresponding re-introduction is omitted, respectively.

### DETAILED DESCRIPTION

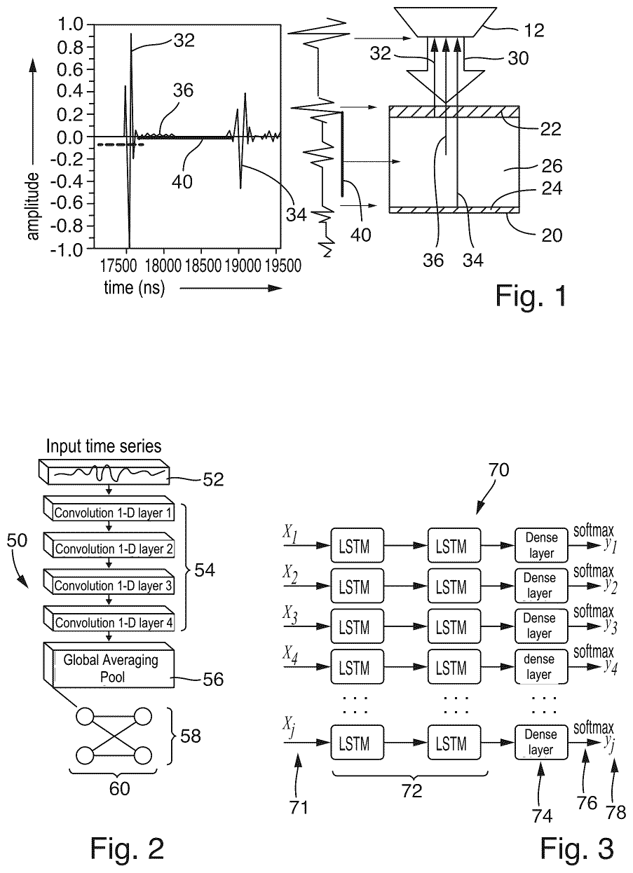

FIG. 1 shows a schematic representation of the signal formation in the scanning acoustic microscopy. As can be seen in the right-hand half of the figure, an ultrasound pulse 30 generated by a pulse generator (not shown), for example a piezoelectric crystal, which usually comprises a frequency between 10 MHz and 2000 MHz, is directed onto a sample 20 to be examined by an ultrasonic transducer 12. On the front surface 22 of the sample 20, a part of the pulse 30 is reflected as an echo 32, another part of the pulse is reflected on the rear surface 24 as an echo 34. In between, another part of the pulse 30 may be reflected as an echo 36 on internal structures and/or flaws in the inner volume 26 of the sample. The returning echoes 32, 34, 36 are in turn directed to a receiver (not shown) by the ultrasonic transducer 12. Hereby, it may be the same piezoelectric crystal that has also generated the pulse 30. Corresponding scanning acoustic microscopes are known.

In the left-hand half of the figure, the chronological sequence of the amplitude of the reflected signal is represented, the so-called A-scan. Corresponding to the shorter travel time, first the echo 32 comes back from the front surface. This one also has the largest amplitude. The substantially weaker echo 36 from the interior of the sample follows, and at last the echo 34 of the pulse comes from the rear surface 24. This signal sequence is also shown schematically in vertical alignment corresponding to the depth profile of the sample 20.

For the analysis of the sample with regard to defects, the middle part of the signal is interesting. Therefore, a temporal gate 40 is applied that excludes the echoes 32, 34 of the pulse 30 from the front surface 22 and the rear surface 24. The signal located within the gate 40 contains a variety of information about the inner life of the sample 20 at the current raster point resp. pixel.

In FIG. 2, a 1-D CNN architecture of a convolutional network (CNN) is schematically represented. The discrete chronological sequence of the amplitude signal in gate 40 (“Input Time Series”), which is introduced into an input layer 52, serves as input signal. This is followed by an order of convolutional planes 54, the so-called convolutional base, followed by an averaging layer 56 (“global averaging pool”) and a classifier 58 with one or more fully linked layers, which issues a number of K initial classifications 60 from which results, whether or not the sample 20 comprises a defect at the current position, and, if applicable, what kind of defect or what kind of structure.

FIG. 3 shows the alternative of a recurrent neural network 70, which comprises a series of LSTM layers 72 on the side of the input 71, followed by a dense layer 74. The output of the dense layer 74 is processed, for example, by means of a softmax function 76 in order to arrive at predictions 78 that correspond to the classifications in a CNN.

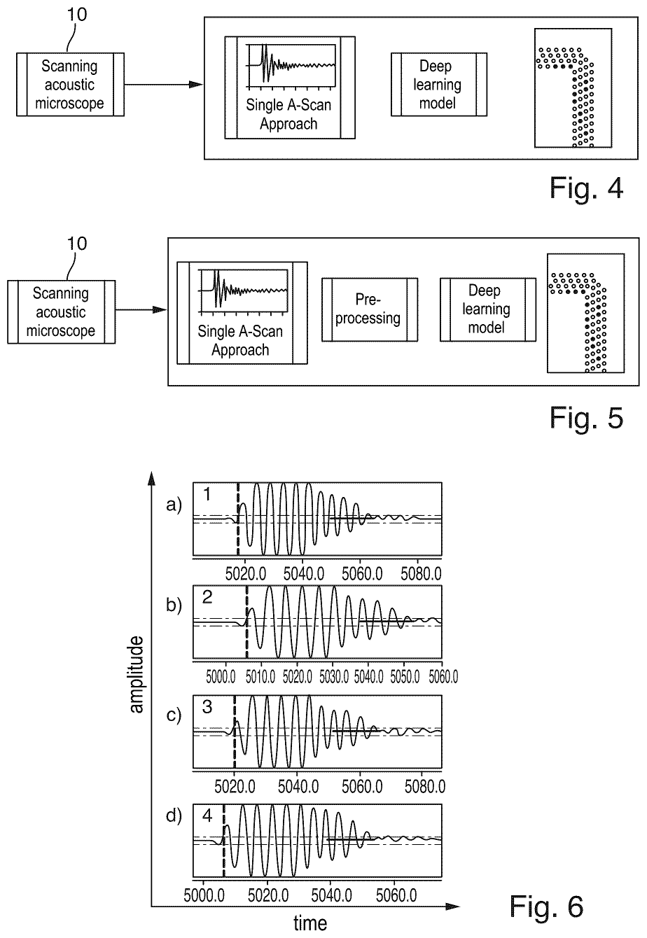

In FIG. 4 an example of an unsupervised deep learning is schematically represented. A scanning acoustic microscope 10 does a scan of a defect-free control sample 20 (“Single A-Scan Approach”) at each raster point. The chronological sequences form a gold standard due to the freedom from defects of the control sample 20. In the following, the neural network is trained on the entire data of the A-scans by means of a deep learning model. In this way, the neural network learns the characteristics of the A-scan sequences for all of the structures contained in the control sample and sets itself up such that it optimally recognizes these signals. Corresponding procedures are known, so that the trained neural network has knowledge of what kinds of signals are to be expected in a proper sample. Later, A-scan signals from defective locations will therefore attract attention and can be identified and marked. This can be recognized in the right-hand partial image, where defects are indicated on a flip chip sample.

In FIG. 5 an alternative method is shown that differs from the one in FIG. 4 in that the A-scan signals are preprocessed prior to the training resp. prior to the analysis, for example, by wavelet filtering, upscaling, or the like.

Instead of unsupervised learning, supervised learning may also take place. In this case, a defective control sample is scanned instead of a defect-free control sample. This is followed by a labeling step in which an expert or another system, which is used for defect recognition, marks regions on the control sample that are characteristic of, if applicable, different, defects, on the one hand, and of, if applicable, different, defect-free structures of the sample. The neural network is then trained towards the aim of reproducing the corresponding defect resp. structure classification as accurately as possible. Procedures for supervised learning are also known.

In FIG. 6 the chronological ultrasound signal sequences in the gate 40 are shown for various of the aforementioned classifications. In this example, the sample is a defective flip chip, corresponding to the respective right-hand representations in FIGS. 4 and 5. The gate start is indicated by a vertical line in each case. From top to bottom, these are: a signal from a defective light solder joint, a signal from a defective dark solder joint, a signal from an intact solder joint, and a signal from another structural region. The naked eye hardly recognizes any differences. A neural network learns during its training, which signal components or structures are characteristic of the various classifications.

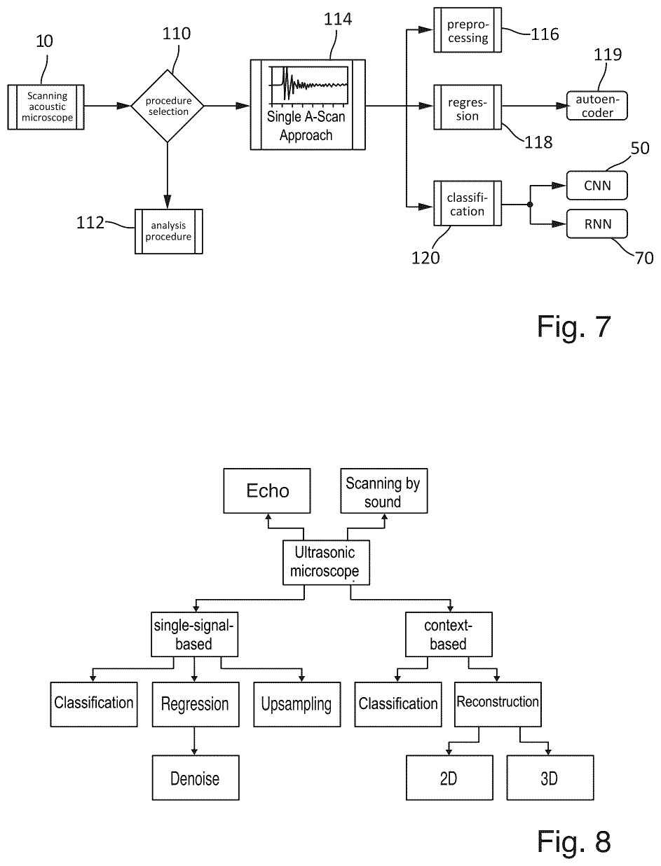

FIG. 7 shows a schematic representation of a general work flow in a data analysis by means of machine learning. A scanning acoustic microscope 10 performs a scan of a sample, i.e., records a chronological sequence of the ultrasound signal at each scanning point on the sample. This is followed by a procedure selection 110, in which an analysis procedure 112 is selected, for example the analysis for each pixel individually or a neighborhood evaluation of, for example, a square region, which comprises, for example, an edge length of 3 or 5 pixels. A number of adjacent pixels of a row or a series or a non-square contiguous region of pixels may be evaluated together, if applicable, with a weighting sloping from the center to the edge of the region.

After selection of the procedure 112, the quantity of the recorded signals is fed to an evaluation. This may take place online and in real time, but also downstream and, if applicable, offline. Therein, the recorded ultrasound signals may be subjected to a preprocessing 116, for instance, an upsampling, a downsampling and/or a filtering, in particular wavelet filtering. A regression 118 may take place, for example, by using an autoencoder 119. An example of this is a neural network that has been trained unsupervised. Also, a classification 120 may take place by using a CNN 50 or RNN 70 trained by means of supervised learning.

FIG. 8 shows a schematic representation of components of a method according to the present disclosure. With reference to the remaining figures, in particular FIG. 1, an scanning acoustic microscope 10 generates a pulse 30, which is switched through by means of an ultrasonic transducer 12 and comes back in the form of various echoes 32, 34, 36 and is digitized and analyzed. A possible, but not exclusive, distribution of functionalities is a single-signal-based or context-based functionality. For example, regression functionalities such as a noise suppression (denoising), or upsampling are typically, but not necessarily, applied to the individual ultrasound signals. The individual ultrasound signals may as well as such already be subjected to a classification by a correspondingly trained neural network.

Context-based functions concern the collective evaluation of the ultrasound signals of adjacent scan points resp. pixels. These may as well be classified by means of correspondingly trained neural networks. Due to the larger number of input data, the neural networks are dimensioned correspondingly larger, but the larger number of available signals also ensures a possibly greater discriminatory power than in the case of the individual signal analysis. These more complex signals collectively evaluated are also very suitable for a 2-D or 3-D reconstruction of the sample, since uncorrelated signal noise is suppressed by the combination of the signals of adjacent raster points, so that a clearer reconstructed image may be produced. A reconstruction may, of course, also take place with the help of the individual signals.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

### LIST OF REFERENCE SIGNS

10 Scanning acoustic microscope
12 Ultrasonic transducer
20 Sample
22 Front surface
24 Rear surface
26 Inner volume
30 Ultrasound pulse
32 Echo from front surface
34 Echo from rear surface
36 Echo from the inner volume
40 Gate
50 CNN
52 Input layer
54 Folding layers
56 Global averaging pool
58 Classifier
60 K output classifications
70 RNN
71 Input
72 LSTM layer
74 Dense layer
76 Softmax evaluation
78 Predictions
110 Procedure selection
112 Selected procedure
114 A-Scan
116 Preprocessing
118 Regression
119 Autoencoder
120 Classification

What is claimed is:

1. A method for automated defect classification of a sample, the method comprising:
scanning, by a scanning acoustic microscope, a sample in a predefined frequency range, wherein:
the scanning acoustic microscope comprises one or more ultrasonic transducers;
the sample is positioned stepwise relative to the one or more ultrasonic transducers at raster points; and
one or more ultrasound signals are generated at each raster point and recorded from at least one of after reflection on the sample, reflection in the sample, and after transmission by the sample;
digitizing one or more chronological sequences of the one or more recorded ultrasound signals reflected and/or transmitted; and
analyzing the digitized one or more chronological sequences for defects by using at least one neural network trained based on a deep learning model that uses training data including scanning acoustic microscope scans of one or more control samples of the same type as the sample.

2. The method according to claim 1, wherein the predefined frequency range is 10 MHz to 2,000 MHz.

3. The method according to claim 1, wherein the one or more ultrasonic transducers are broadband ultrasonic transducers, and the method further comprising:
recording, by the one or more ultrasonic transducers, signals produced from at least one of mode conversion, multiple echoes, Rayleigh waves, Lamb waves and due to intrinsic properties of the one or more ultrasonic transducers; and
forwarding, by the one or more ultrasonic transducers, the recorded signals to a receiver.

4. The method according to claim 3, wherein the one or more ultrasonic transducers are broadband ultrasonic transducers with a bandwidth of at least 10%.

5. The method according to claim 1, wherein the at least one neural network comprises a neural convolutional network (CNN), and the deep learning model is a recurrent neural network (RNN) having one of a Long Short-Term Memory (LSTM) and Gated Recurrent Unit (GRU)-based architecture.

6. The method according to claim 5, wherein the CNN is a CNN with a 1-D-resnet architecture with 1-dimensional convolutional blocks.

7. The method according to claim 1, wherein the deep learning model comprises an automated feature extraction.

8. The method according to claim 1, wherein the deep learning model comprises an adaptation of one of a feed-forward stage of an RNN and a hybrid of a CNN and an RNN.

9. The method according to claim 1, further comprising prior to the analyzing, smoothing the one or more ultrasound signals.

10. The method according to claim 9, wherein the smoothing comprises using wavelet filtering based on one of Daubechies wavelets and Mexican hat wavelets.

11. The method according to claim 1, wherein the analyzing the digitized one or more chronological sequences comprises one of:
analyzing the digitized one or more chronological sequences as a discrete time series in a form {signal length×1}; and
performing a volumetric analysis.

12. The method according to claim 11, wherein the discrete time series is a discrete time series of raster points arranged in a rectangle of edge lengths n×m, as a data set of a form {signal length×n×m}, and wherein at least one of n and m is ≥2, n=m, and n and m are odd numbers.

13. The method according to claim 1, wherein:
data sets of the one or more ultrasound signals are two-dimensional;
the one or more ultrasound signals is in a first dimension; and
time steps of one is in a second dimension.

14. The method according to claim 1, wherein analyzing the digitized one or more chronological sequences comprises classifying the digitized one or more chronological sequences into at least one of:
one or more classes for an absence of defects;
one or more classes for one or more structures; and
one or more classes for defects including different kinds of defects.

15. The method according to claim 1, wherein the analyzing comprises determining a confidence for each raster point.

16. The method according to claim 15, wherein a confidence of a raster points is represented by an intensity value of the raster point.

17. The method according to claim 1, wherein the analyzing comprises superimposing a confidence onto a C-scan image as one of a color and gray scale value for raster points with a defect classification.

18. The method according to claim 17, wherein the confidence is integrated as one of a brightness parameter, a color parameter and a transparency parameter.

19. The method according to claim 1, further comprising, prior to the analyzing, converting the one or more ultrasound signals using regression techniques.

20. The method according to claim 19, wherein:
the regression techniques comprise interpolation of a trained statistical model into a signal of a predefined length and/or predefined chronological increment;
the converting is performed without loss of information with regard to the sample; and
the converting reduces at least one of noise, signal artifacts and interference signals and distortions.

21. The method according to claim 1, further comprising correcting the one or more ultrasound signals using an encoder-decoder architecture, wherein:
the one or more ultrasound signals are decomposed into components and reconstructed again based on trained domain knowledge,
a reconstruction error is derived from a difference between an input signal and the reconstructed signal, and
the input signal is associated with the one or more chronological sequences.

22. The method according to claim 1, further comprising generating a reconstructed 3-D data set of a sample volume of the sample by using a trained statistical model in consideration of properties of ultrasound propagation in the sample, which is corrected for effects by defocusing, multiple echoes, mode-converted signals, and intrinsic transducer signals to allow a generation of sectional images along any planes.

23. The method according to claim 1, wherein the at least one neural network is trained based on at least one control sample of foreign types of at least one foreign sample type.

24. The method according to claim 1, wherein the at least one neural network is trained based on labeling of defects and other parts of the one or more control samples by an user input on a C-scan section, wherein:
the defects and parts labeled by the user input account for less than 50% of an area of the scan of the one or more control samples.

25. A computer program product for automated defect classification of a sample, the computer program product comprising a computer readable storage medium storing program code, the program code being executable by a processing element of a scanning acoustic microscope to cause the scanning acoustic microscope to:
scan a sample in a predefined frequency range, wherein the scanning acoustic microscope comprises one or more ultrasonic transducers, the sample is positioned stepwise relative to the one or more ultrasonic transducers at raster points, and one or more ultrasound signals are generated at each raster point and recorded after at least one of reflection on the sample and transmission by the sample,
digitize one or more chronological sequences of the one or more recorded ultrasound signals reflected and/or transmitted; and
analyze the digitized one or more chronological sequences for defects using at least one neural network, wherein the at least one neural network is trained based on a deep learning model that uses training data including scanning acoustic microscope scans of one or more control samples of the same type as the sample.

26. A scanning acoustic microscope comprising:
a positioning system with a holder for a sample;
at least one ultrasonic transducer that is a broadband ultrasonic transducer;
a pulse generator; and receiver connected with the at least one ultrasonic transducer;
a processor; and
an analog-to-digital converter,
wherein the scanning acoustic microscope is configured to:
scan the sample in a predefined frequency range, wherein, the sample is positioned stepwise relative to the at least one ultrasonic transducer at raster points, and one or more ultrasound signals are generated at each raster point and recorded after at least one of reflection on the sample and transmission by the sample,
digitize one or more chronological sequences of the one or more recorded ultrasound signals reflected and/or transmitted; and
analyze the digitized one or more chronological sequences for defects using at least one neural network, wherein the at least one neural network is trained based on a deep learning model that uses training data including scanning acoustic microscope scans of one or more control samples of the same type as the sample.

27. A method for automated defect classification of a sample, the method comprising:
acquiring one or more recorded ultrasound signals from a scanning acoustic microscope that scans a sample in a predefined frequency range, wherein:
the scanning acoustic microscope comprises one or more ultrasonic transducers;
the sample is positioned stepwise relative to the one or more ultrasonic transducers at raster points; and
the one or more ultrasound signals are generated at each raster point and recorded after at least one of reflection on the sample and transmission by the sample;
digitizing one or more chronological sequences of the one or more recorded ultrasound signals reflected and/or transmitted; and
analyzing the digitized one or more chronological sequences for defects using at least one neural network, wherein the at least one neural network is trained based on a deep learning model that uses training data including scanning acoustic microscope scans of one or more control samples of the same type as the sample.
